(19) United States
(12) Patent Application Publication
(10) Pub. No.: US 2025/0332054 A1
(43) Pub. Date: Oct. 30, 2025

(54) MOBILITY AIDS AND HEIGHT ADJUSTMENT MECHANISMS THEREOF

(71) Applicant: Medical Depot, Inc., Port Washington, NY (US)

(72) Inventor: Bradley Shelowitz, Long Beach, NY (US)

(73) Assignee: Medical Depot, Inc., Port Washington, NY (US)

(21) Appl. No.: 18/650,452

(22) Filed: Apr. 30, 2024

(51) Int. Cl. A61H 3/04

(52) U.S. Cl. CPC A61H 3/04; A61H 2201/0192

(57) ABSTRACT

A height adjustment mechanism of a mobility aid selectively locks a height of a handle or an armrest of the mobility aid and reduces shaking and/or rattling between a vertical shaft and a frame of the mobility aid.

### BACKGROUND

### Technical Field

The present disclosure relates to mobility aids, and more particularly, to mechanisms for setting a selected height of a handle or armrest of a mobility aid.

### Background of Related Art

Rollators facilitate an individual's ability to walk and be independently mobile by providing stabilization, support, and/or reducing the burden on the individual's lower body. A typical rollator includes a frame supported on three to four wheels, handlebars, and a seat. The height or vertical position of the handlebars relative to the frame may be adjusted to correspond to the height of the user.

Each handlebar is typically fixed on a vertical tube, which is slidably received in a corresponding sleeve of the frame to allow for height adjustment of the handlebar. It is important that the adjustability of the handlebar height is user-friendly, the handlebar remains locked in its vertical position during use, and rattling of the vertical tube within the sleeve of the frame is minimized. There is a continuing need to provide a height adjustment mechanism that satisfies at least all of the above requirements.

### SUMMARY

In accordance with an aspect of the present disclosure, a mobility aid is provided and includes a left-side frame, a right-side frame coupled to the left-side frame, a plurality of wheels supporting the left-side and right-side frames, first and second shafts each defining a plurality of axially-spaced locking apertures, and a first adjustment mechanism. The first shaft is configured to slide relative to the left-side frame to adjust a position of an end of the first shaft relative to the left-side frame. The second shaft is configured to slide relative to the right-side frame to adjust a position of an end of the second shaft relative to the right-side frame. The first adjustment mechanism includes a sleeve defining a passageway therethrough and fixedly coupled to the left-side frame, an actuator movably coupled to the sleeve, a locking pin movably supported in the sleeve, and a friction member movably supported in the sleeve. The first shaft extends through the passageway of the sleeve. The locking pin is configured for receipt in a first locking aperture of the plurality of locking apertures of the first shaft in response to an actuation of the actuator. The friction member is configured to press against the first shaft in response to an actuation of the actuator to resist shaking of the first shaft relative to the left-side frame.

In aspects, the friction member may define a channel, and the locking pin may be movably received in the channel of the friction member.

In aspects, the actuation of the actuator may drive the locking pin relative to the friction member and into the first locking aperture when the locking pin is in horizontal registration with the first locking aperture. The actuation of the actuator may also drive the friction member into pressing engagement with the first shaft.

In aspects, the adjustment mechanism may further include a biasing member received in the channel of the friction member and operably engaged with the locking pin such that the biasing member biases the locking pin to a position in which the locking pin is external of the plurality of locking apertures.

In aspects, the actuator may be a lever rotationally coupled to the sleeve. The lever may include a cam configured to engage the locking pin and/or the friction member.

In aspects, the cam of the lever may be configured to drive axial movement of the locking pin and the friction member in response to a rotation of the lever.

In aspects, the mobility aid may further include a haptic mechanism extending into the passageway of the sleeve and into engagement with the first shaft. The haptic mechanism may be configured to selectively engage a second locking aperture that is positioned adjacent the first locking aperture.

In aspects, the haptic mechanism and the locking pin may be spaced an axial distance from one another equal to an axial distance defined between the first locking aperture and the second locking aperture.

In aspects, the sleeve may define a first channel positioned at a first side of the sleeve, and a second channel positioned at the first side of the sleeve and in vertical alignment with the first channel. The locking pin may extend through the first channel, and the haptic mechanism may extend through the second channel.

In aspects, the haptic mechanism may include an elongate member axially supported by the sleeve, and a ball slidably supported by the elongate member and spring-biased toward engagement with the first shaft.

In aspects, the mobility aid may further include a first handle supported at a top end of the first shaft, and a second handle supported at a top end of the second shaft. A vertical position of the first handle relative to the left-side frame may be adjustable by sliding the first shaft relative to the left-side frame, and a vertical position of the second handle relative to the right-side frame may be adjustable by sliding the second shaft relative to the right-side frame.

In aspects, the left-side frame may include a left upright support. The sleeve may be fixed about the left upright support and the first shaft may be slidably received in the left upright support.

In accordance with another aspect of the present disclosure, an adjustment mechanism for adjusting a position of a handle or an armrest of a mobility aid is provided. The adjustment mechanism includes a sleeve defining a passageway therethrough, an actuator movably coupled to the sleeve, a locking pin movably supported in the sleeve and configured to move relative to the sleeve in response to an actuation of the actuator, and a friction member movably supported in the sleeve and configured to move relative to the sleeve in response to the actuation of the actuator.

In aspects, the friction member may define a channel, and the locking pin may be movably received in the channel of the friction member.

In aspects, the actuation of the actuator may drive the locking pin relative to the friction member, and drive the friction member relative to the sleeve.

In aspects, the adjustment mechanism may further include a biasing member received in the channel of the friction member and engaged with the locking pin. The biasing member may be configured to resiliently bias the locking pin away from the friction member and toward the actuator.

In aspects, the actuator may include a cam engaged with a head of the locking pin and configured to drive axial movement of the locking pin and the friction member in response to a rotation of the actuator relative to the sleeve.

In aspects, the adjustment mechanism may further include a haptic mechanism extending into the passageway of the sleeve. The haptic mechanism may be configured to releasably engage a locking aperture of the mobility aid independently of the actuation of the actuator.

In aspects, the sleeve may define a first channel positioned at a first side of the sleeve, and a second channel positioned at the first side of the sleeve and in vertical alignment with the first channel. The locking pin may extend through the first channel, and the haptic mechanism may extend through the second channel.

In aspects, the haptic mechanism may include an elongate member axially supported by the sleeve, and a ball slidably supported by the elongate member and spring-biased away from an end of the elongate member.

As used herein, the terms parallel and perpendicular are understood to include relative configurations that are substantially parallel and substantially perpendicular up to about +or −15 degrees from true parallel and true perpendicular.

As used herein, the term “about” means that the numerical value is approximate and small variations would not significantly affect the practice of the disclosed embodiments. Where a numerical limitation is used, unless indicated otherwise by the context, “about” means the numerical value can vary by +10% and remain within the scope of the disclosed embodiments.

### BRIEF DESCRIPTION OF THE DRAWINGS

Embodiments of the present disclosure are described herein with reference to the accompanying drawings, wherein:

FIG. 1 is a front perspective view illustrating an exemplary embodiment of a rollator shown in an expanded or operational configuration;

FIG. 2A is a top view illustrating a height adjustment mechanism for use with the rollator of FIG. 1

FIG. 2B is a perspective view illustrating the height adjustment mechanism of FIG. 2A;

FIG. 2C is a plan view illustrating the height adjustment mechanism of FIG. 2A;

FIG. 2D is a side view illustrating the height adjustment mechanism of FIG. 2A;

FIG. 3 is a perspective view, with parts separated, illustrating a locking assembly of the height adjustment mechanism of FIGS. 2A-2D;

FIG. 4 is a longitudinal cross-sectional view of a haptic mechanism of the height adjustment mechanism of FIGS. 2A-2D;

5A is a side, cross-sectional view illustrating the height adjustment mechanism in an unlocked state; and

FIG. 5B is a side, cross-sectional view illustrating the height adjustment mechanism in a locked state.

### DETAILED DESCRIPTION

Embodiments of the presently disclosed mobility aids and height adjustment mechanisms thereof are described in detail with reference to the drawings, in which like reference numerals designate identical or corresponding elements in each of the several views.

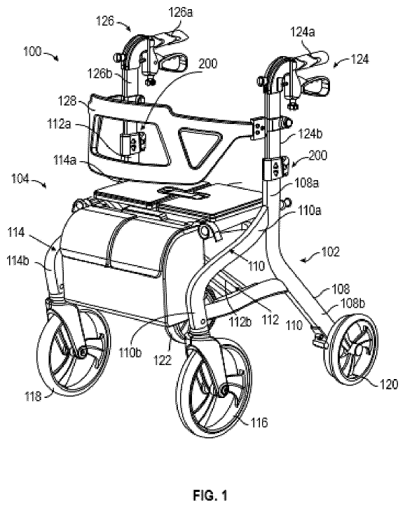

With reference to FIG. 1, an exemplary embodiment of a mobility aid 100 is shown. While the mobility aid 100 illustrated in the figures is a rollator, it is contemplated that the mobility aid 100 may be any suitable type such as a wheelchair, a standard walker, an upright walker, or the like. The mobility aid 100 generally includes a left-side frame 102, and a right-side frame 104 coupled to the left-side frame 102 by a folding mechanism (not explicitly shown) that selectively transitions the mobility aid 100 between an expanded or operational configuration (FIG. 1) and a collapsed or stored configuration (not shown).

Each of the left-side and right-side frames 102, 104 includes a respective rear leg 108, 112, and a front leg 110, 114. The rear legs 108, 112 may have an upright support 108a, 112a, and a lower end 108b, 112b. The left and right upright supports 108a, 112a may be monolithically formed with or connected (e.g., welded) to the remainder of the rear leg 108, 112. The front legs 110, 114 of each of the respective left and right-side frames 102, 104 include an upper end 110a, 114a connected to the respective left and right upright supports 108a, 112a, and a lower end 110b, 114b. The lower end 110b, 114b of each of the front legs 110, 114 has a wheel or wheel assembly 116, 118 rotatably coupled thereto, and the lower end 108b, of each of the rear legs 108, 112 has a wheel 120, 122 coupled thereto.

The mobility aid 100 further includes a first or left handle assembly 124 coupled to the left-side frame 102 and a second or right handle assembly 126 coupled to the right-side frame 104. Each of the handle assemblies 124, 126 includes a shaft 124b, 126b and a handlebar 124a, 126a extending rearwardly of the shaft 124b, 126b. The shafts 124b, 126b of the handle assemblies 124, 126 are slidably received in the upright supports 108a, 112a of the rear legs 108, 112 of the respective left-side and right-side frames 102, 104 to allow for a selective adjustment of the height of the handlebars 124a, 126a relative to the frames 102, 104. A back support 128 may be attached to the shafts 124b, 126b of the handle assemblies 124, 126 and extends frontwardly therefrom. It is contemplated that the back support 128 may be coupled to other suitable locations of the mobility aid 100. Each of the left-side and right-side frames 102, 104 further includes a height adjustment mechanism 200 fixedly secured to and about a top end of the upright supports 108a, 112a.

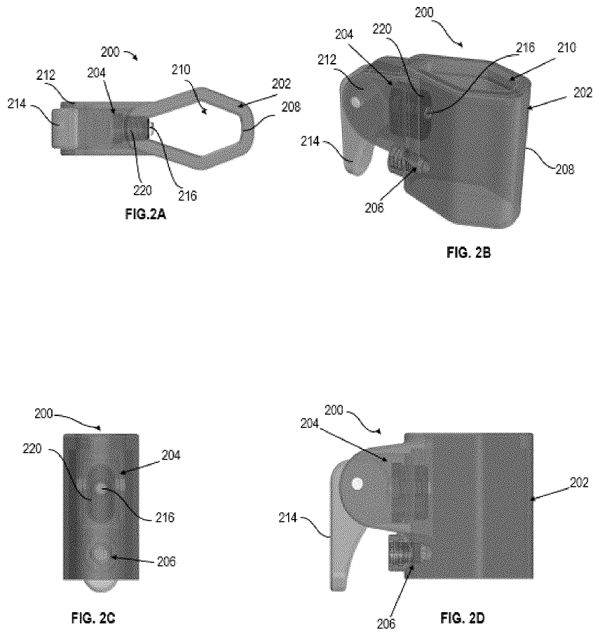

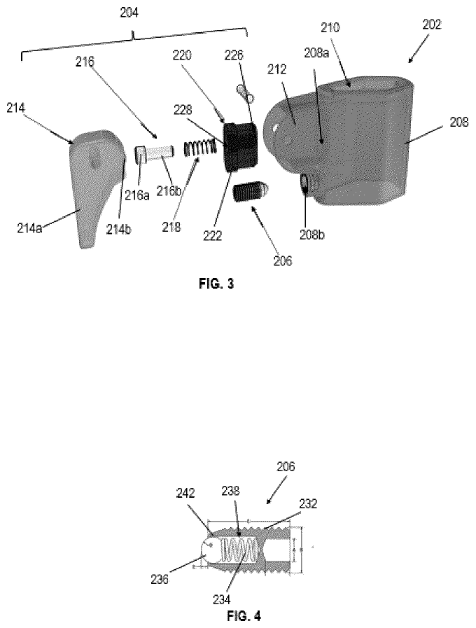

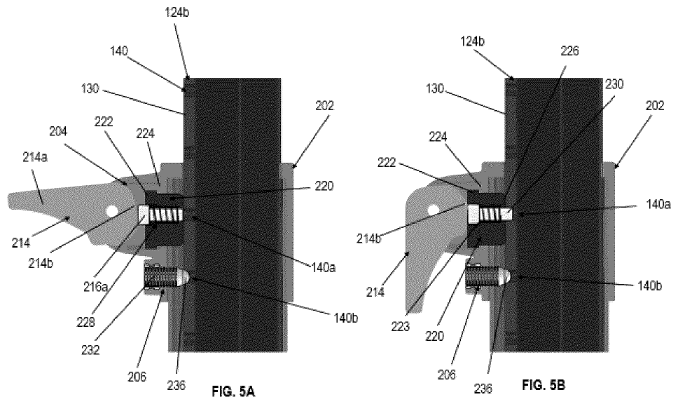

With reference to FIGS. 2A-2D, 3, 5A, and 5B, the height adjustment mechanism 200 of each the left-side frame 102 and the right-side frame 104 generally includes a sleeve 202 fixedly coupled to the upper end of the upright supports 108a, 112a (FIG. 1), a locking assembly 204 positioned in the sleeve 202, and a haptic mechanism 206 positioned in the sleeve 202. The sleeve 202 includes a collar 208 defining a passageway 210 therethrough, and a housing 212 extending outwardly from the collar 208. The collar 208 is positioned about the upper end of the upright support 108a and a portion of the handlebar shaft 124b. The handlebar shaft 124b is configured to move axially through the passageway 210 of the sleeve 202 and relative to the upright support 108a when the mechanism 200 is in the unlocked state (FIG. 5A). The collar 208 defines a first or upper channel 208a (FIG. 3) and a second or lower channel 208b each located at a first side of the collar 208. The upper and lower channels 208a, 208b extend radially through the collar 208 such that the upper and lower channels 208a, 208b are perpendicular relative to the passageway 210 of the collar 208.

The locking assembly 204 is configured to selectively lock the handlebar shaft 124b in a vertical position relative to the frame 102. The locking assembly 204 includes an actuator, such as, for example, a lever 214, a locking pin 216, a biasing member 218, and a friction member, such as, for example, a sliding block 220. The lever 214 is movably coupled to the housing 212 of the sleeve 202. For example, the lever 214 may be rotatable (e.g., via a pivot pin) relative to the sleeve 202 about a rotational axis that is perpendicular to the passageway 210 of the sleeve 202. In other aspects, the lever 214 may be slidable relative to the sleeve 202. The lever 202 includes a lever arm 214a protruding from the housing 212 of the sleeve 202, and a cam 214b at least partially received in the housing 212 of the sleeve 202. Each of the biasing member 218, the locking pin 216, and the sliding block 220 are supported in the sleeve 202 adjacent the cam 214b of the lever 214 and protrude into the passageway 210 of the sleeve 202.

With reference to FIGS. 3 and 5B, the sliding block 220 may be a rigid or soft block and includes a radial projection 222 configured to engage an inner ledge 224 of the sleeve 202 when the lever 214 is in a locked state (FIG. 5B). The sliding block 220 further includes a flat end face 226 fabricated from a resilient material, such as, for example, plastic, silicone, or the like. The end face 226 is configured to frictionally engage an outer peripheral surface 130 of the handlebar shaft 124b when the lever 214 is in the locked state to prevent rattling, shaking, or the like between the handlebar shaft 124b and the upright support 108a (FIG. 1). In other aspects, the end face 226 of the sliding block 220 may be fabricated from a rigid material.

The locking pin 216 and the biasing member 218 are received in a channel 228 defined centrally through the sliding block 220. The locking pin 216 is axially restrained between the cam 214b of the lever 214 and the biasing member 218. The biasing member 218 may be a coil spring and resiliently biases the locking pin 216 toward an unlocked state (FIG. 5A). The locking pin 216 includes a head 216a engaged with the cam 214b of the lever 214, and a shaft 216b that extends through the channel 228 of the sliding block 220. The biasing member 218 biases the head 216a of the locking pin 216 into engagement with the cam 214b of the lever 214. The shaft 216b of the locking pin 216 has an end 230 (FIG. 5B) configured to be inserted into a selected locking aperture (e.g., a first locking aperture 140a) of a plurality of locking apertures 140 defined along a length of the handlebar shaft 124b when the lever 214 is in a locked state and the selected locking aperture 140a is axially aligned with the locking pin 216. When the shaft 216b of the locking pin 216 is received in the selected locking aperture 140a, the locking pin 216 prevents the handlebar shaft 124b from moving axially relative to the sleeve 202, and therefore the left-side frame 102.

With reference to FIGS. 4, 5A, and 5B, the height adjustment mechanism 200 may further include the haptic mechanism 206, which may be positioned below and in vertical alignment with the locking assembly 204. The haptic mechanism 206 is configured to tactually and/or audibly indicate to a user when the locking pin 216 of the locking assembly 204 is coaxially aligned with a selected locking aperture 140 of the handlebar shaft 124b during a height adjustment of the handlebar shaft 124b. The haptic mechanism 206 may include an elongate member, such as, for example, a screw 232 received within the lower channel 208b of the collar 208, a spring 234, and a ball 236. The screw 232 is threadedly coupled to a threaded inner surface that defines the lower channel 208b, and the spring 234 is received within an internal channel 238 of the screw 232.

The ball 236 of the haptic mechanism 206 is axially restrained within the screw 232 by the spring 234 and a tapered inner wall 242 of the screw 232. The ball 236 and the end 230 of the locking pin 216 of the locking assembly 204 are axially spaced from one another the same vertical distance as a pair of adjacent locking apertures 140a, 140b of the handlebar shaft 124b. As such, upon the locking pin 216 of the locking assembly 204 being axially aligned with the first locking aperture 140a, the ball 236 of the haptic mechanism 206 is aligned with the second locking aperture 140b. The spring 234 is configured to resiliently bias the ball 236 toward a protruding position in which an outer portion of the ball 236 protrudes longitudinally from an end of the screw 232. The ball 236 is configured to move inwardly into the channel 238 of the screw 232 against the resilient bias of the spring 234 when an outer peripheral surface 130 of the handlebar shaft 124b engages the ball 236.

In operation, with the lever 214 of the locking assembly 204 in the unlocked position (FIG. 5A), the locking pin 216 is positioned externally of the locking apertures 140 of the handlebar shaft 124b and the sliding block 220 is not pressingly engaged with the handlebar shaft 124b. As such, a user may easily axially move the handlebar shaft 124b relative to the sleeve 202 to adjust a height of the handlebar 124a to a desired elevation relative to a ground surface. During an initial sliding of the handlebar shaft 124b to adjust the height of the handlebar 124a from a first vertical position toward a second vertical position, the ball 236 of the haptic mechanism 206 is pushed out of a locking aperture 140a of the handlebar shaft 124b. Upon the handlebar shaft 124b reaching the second vertical position, the ball 236, via the spring 234, engages an adjacent locking aperture 140b, which is felt in the hand by the user. In some aspects, the ball 236 entering the locking aperture 140 may produce an audible sound to indicate to the user that the next locking position is reached. Should the user find the selected locking position preferable, the user may lock the handlebar 124a in the selected vertical position by rotating the lever 214 of the locking assembly 204.

Rotation of the lever 214 drives an axial movement of the locking pin 216 toward the locking aperture 140a of the handlebar shaft 124b via the cam 214b of the lever 214. Prior to or concurrent with the end 230 of the locking pin 216 being fully received within the locking aperture 140a, the rotation of the lever 214 drives an axial movement of the sliding block 220 toward the handlebar shaft 124b. For example, the cam 214b of the lever 214 may drive the head 216a of the locking pin 216 into engagement with an inner ledge 223 (FIG. 5B) of the sliding block 220 such that continued rotation of the lever 214 presses the sliding block 220 into forcible, pressing engagement with the outer peripheral surface 130 of the handlebar shaft 124a, whereby any rattling and/or shaking between the inner periphery of the sleeve 202/upright support 108a (FIG. 1) and the outer peripheral surface 130 of the handlebar shaft 124b is reduced or eliminated.

Accordingly, the handle height adjustment mechanism 200 of the present disclosure accomplishes two functions with a single actuation of a single lever 214, namely, locking the selected height of the handle 124a and reducing or eliminating any shaking or rattling that may occur due to an imperfect fit between the handlebar shaft 124b and the upright support 108a of the frame 102 as a result of, for example, manufacturing tolerances. In some aspects, the mechanism 200 may be used to adjust positions of armrests, handles, or the like other than a vertical position, such as, for example, a horizontal position.

It will be understood that various modifications may be made to the embodiments disclosed herein. Therefore, the above description should not be construed as limiting, but merely as exemplifications of various embodiments. Those skilled in the art will envision other modifications within the scope and spirit of the claims appended thereto.

What is claimed is:

1. A mobility aid, comprising:
a left-side frame;
a right-side frame coupled to the left-side frame;
a plurality of wheels supporting the left-side and right-side frames;
a first shaft defining a plurality of axially-spaced locking apertures, the first shaft being configured to slide relative to the left-side frame to adjust a position of an end of the first shaft relative to the left-side frame;
a second shaft defining a plurality of axially-spaced locking apertures, the second shaft being configured to slide relative to the right-side frame to adjust a position of an end of the second shaft relative to the right-side frame; and
a first adjustment mechanism including:
an actuator movably coupled to the left-side frame;
a locking pin movably coupled to the left-side frame and configured for receipt in a first locking aperture of the plurality of locking apertures of the first shaft in response to an actuation of the actuator; and
a friction member movably coupled to the left-side frame and configured to press against the first shaft in response to the actuation of the actuator to resist shaking of the first shaft relative to the left-side frame.

2. The mobility aid according to claim 1, wherein the actuation of the actuator drives the locking pin into the first locking aperture when the locking pin is in horizontal registration with the first locking aperture, and drives the friction member into pressing engagement with the first shaft.

3. The mobility aid according to claim 2, wherein the adjustment mechanism further includes a biasing member operably engaged with the locking pin such that the biasing member biases the locking pin to a position in which the locking pin is external of the plurality of locking apertures.

4. The mobility aid according to claim 1, wherein the actuator is a lever, the lever including a cam configured to engage at least one of the locking pin or the friction member.

5. The mobility aid according to claim 4, wherein the cam of the lever is configured to drive axial movement of the locking pin and the friction member in response to a rotation of the lever.

6. The mobility aid according to claim 1, further comprising:
a first handle supported at a top end of the first shaft, wherein a vertical position of the first handle relative to the left-side frame is adjustable by sliding the first shaft relative to the left-side frame; and
a second handle supported at a top end of the second shaft, wherein a vertical position of the second handle relative to the right-side frame is adjustable by sliding the second shaft relative to the right-side frame.

7. The mobility aid according to claim 6, wherein the left-side frame includes a left upright support, the first shaft being slidably received in the left upright support.

8. An adjustment mechanism for adjusting a position of a handle or an armrest of a mobility aid, the adjustment mechanism comprising:
a sleeve defining a passageway therethrough;
an actuator movably coupled to the sleeve;
a locking pin movably supported in the sleeve and configured to move relative to the sleeve in response to an actuation of the actuator; and
a friction member movably supported in the sleeve and configured to move relative to the sleeve in response to the actuation of the actuator.

9. The adjustment mechanism according to claim 8, further comprising a biasing member engaged with the locking pin, the biasing member being configured to resiliently bias the locking pin toward the actuator.

10. The adjustment mechanism according to claim 8, wherein the actuator includes a cam engaged with a head of the locking pin and configured to drive axial movement of the locking pin and the friction member in response to a rotation of the actuator relative to the sleeve.
